(19) United States
(12) Patent Application Publication
(10) Pub. No.: US 2025/0301967 A1
(43) Pub. Date: Oct. 2, 2025

(54) SENSOR-ACTIVATED LIGHTING SYSTEM FOR AGRICULTURAL GROWING TABLE

(71) Applicant: Jerry A. Main, Jr., Toledo, OH (US)

(72) Inventor: Jerry A. Main, Jr., Toledo, OH (US)

(21) Appl. No.: 18/864,584

(22) PCT Filed: May 9, 2023
(86) PCT No.: PCT/US2023/066753

§ 371 Date: Nov. 11, 2024

Related U.S. Application Data
(60) Provisional application No. 63/339,555, filed on May 9, 2022.

(51) Int. Cl. A01G 9/24; A01G 7/04; F21V 14/02; F21V 23/04; F21Y 115/10

(52) U.S. Cl. CPC A01G 9/249; A01G 7/045; F21V 14/02; F21V 23/0471; F21Y 2115/10

(57) ABSTRACT

A sensor-activated lighting system is provided. The sensor-activated lighting system includes a plurality of lighting elements positioned proximate to one or more plants. The lighting elements are configured to provide light spectrums and intensities suitable for the growing the plants. A plurality of sensors is mounted in proximity to the plants and is configured to sense a plant related parameter. The sensors are further configured to communicate the sensed parameter. A motive force receives the communication from the sensors actuates movement the lighting elements in a vertical direction in response to the received communication. The sensors and the motive force cooperate to automate the vertical movement of the plurality of lighting elements based on the parameter sensed by the plurality of sensors, thereby maximizing a lighting efficiency of the plurality of lighting elements while avoiding the infliction of harm to the plants due to excessive light intensities.

### RELATED APPLICATIONS

This application claims the benefit of U.S. Provisional Application No. 63/339,555 filed on May 9, 2022. The entire disclosure of the above application is incorporated herein by reference.

### FIELD

The present invention relates generally to an agricultural growing table and more particularly, to a lighting system for use with an agricultural growing table.

### INTRODUCTION

This section provides background information related to the present disclosure which is not necessarily prior art.

Certain plants can be grown indoors under artificial light. Growing plants indoors advantageously provides the grower with complete control over the growing environment.

To grow certain plants indoors, a growing medium, water, nutrients, lighting and air need to be supplied to the plants. In other instances, the plants can be grown with the use of soilless methods, commonly referred to as hydroponics.

Lighting from conventional lighting systems can include metal halide based systems, ceramic metal halide based systems, high pressure sodium vapor based systems and/or LED-based technologies. Since indoor plants can require both dark and light photoperiods, a timer is commonly used to switch the lighting systems on and off at set intervals. In addition, reflectors can be used with the lighting systems to maximize light efficiency.

A distance is formed between the indoor plants and overhead-mounted lighting systems. The formed distance provides the growers with a balance of maximizing the efficiency of the lighting system while avoiding the infliction of harm to the indoor plants. Often, the distance between lighting system and the indoor plants is adjustable and can be in a range of 10 cm (4 inches) to 0.6 m (2 ft).

Often the distance between conventional lighting systems and the indoor plants is controlled with overhead mechanisms involving rigging and pulleys. The overhead mechanisms are typically attached to ceiling of the growing facility and/or other overhead structural systems, such as for example ceiling trusses. The overhead mechanisms are typically manually manipulated to adjust the distance between the indoor plants to the lighting system. Such arrangements can be expensive, hard to change and time consuming to operate.

It would be advantageous if adjustment of lighting systems used with indoor agricultural growing tables could be improved.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the sensor-activated lighting system for agricultural growing tables.

In accordance with the instant disclosure, the above objects as well as other objects not specifically enumerated are achieved by a sensor-activated lighting system for use with agricultural growing tables. The sensor-activated lighting system includes a plurality of lighting elements positioned proximate to one or more plants. The plurality of lighting elements is configured to provide light spectrums and intensities suitable for the growing the one or more plants. A plurality of sensors is mounted in proximity to the one or more plants and is configured to sense a parameter related to the plurality of plants. The plurality of sensors is further configured to communicated the sensed parameter. A motive force is configured to receive communication from the plurality of sensors and is configured to actuate movement the plurality of lighting elements in a vertical direction in response to the received communication. The sensors and the motive force cooperate to automate the vertical movement of the plurality of lighting elements based on the parameter sensed by the plurality of sensors, thereby maximizing a lighting efficiency of the plurality of lighting elements while avoiding the infliction of harm to the one or more plants due to excessive light intensities.

In accordance with the instant disclosure, the above objects as well as other objects not specifically enumerated are also achieved by a method of using a sensor-activated lighting system with an agricultural growing table. The method includes the steps of positioning a plurality of lighting elements proximate to one or more plants, the plurality of lighting elements configured to provide light spectrums and intensities suitable for the growing the one or more plants, mounting a plurality of sensors in proximity to the one or more plants, configuring the plurality of sensors to sense one or more parameters related to the plurality of plants, communicating the one or more sensed parameters to a controller, actuating movement of the plurality of lighting elements in a vertical direction with a motive force as directed by the controller in response to the sensed parameter, wherein the plurality of sensors and the motive force cooperate to automate the vertical movement of the plurality of lighting elements based on the parameter sensed by the plurality of sensors, thereby maximizing a lighting efficiency of the plurality of lighting elements while avoiding the infliction of harm to the indoor door plants due to excessive light intensities.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a first embodiment of a sensor-activated lighting system for agricultural growing tables in accordance with the invention.

FIG. 2A is a plan view of a framework of the sensor-activated lighting system of FIG. 1.

FIG. 2B is a side view of the framework of the sensor-activated lighting system for agricultural growing tables of FIG. 2A.

FIG. 3 is a side view of a second embodiment of a sensor-activated lighting system for agricultural growing tables, shown in an alternate mounting arrangement.

FIG. 4 is a side view of a third embodiment of a sensor-activated lighting system for agricultural growing tables, shown in another alternate mounting arrangement.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The description and figures disclose a sensor-activated lighting system for agricultural growing tables. The sensor-activated lighting system for agricultural growing tables is configured to automate the positioning and repositioning of the lighting system in proximity to indoor plants. More specifically, the lighting system automates the vertical movement of a plurality of lights to one or more pre-determined distances from indoor plants positioned to receive light from the plurality of lights. In this manner, the lighting system advantageously maximizes the lighting efficiency of the plurality of lights while avoiding the infliction of harm to the indoor door plants.

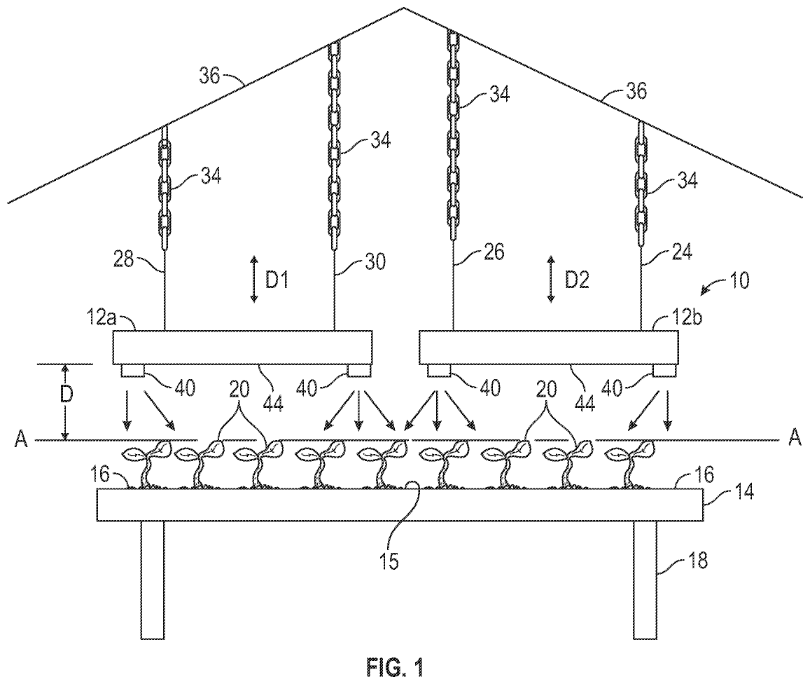

Referring now to FIG. 1, a first embodiment of a sensor-activated lighting system for agricultural growing tables (hereafter “sensor-activated lighting system”) is shown generally at 10. The sensor-activated lighting system 10 includes a plurality of frameworks 12a, 12b positioned vertically above one or more agricultural growing tables 14. Each of the agricultural growing tables 14 includes a growing medium 15 having an upper surface 16. Each of the agricultural growing tables 14 is supported by a plurality of table legs 18. A plurality of plants 20 are positioned in the growing medium 15. Each of the plurality of plants 20 grow in a generally upward direction from the upper surface 16 toward the plurality of frameworks 12a, 12b.

Referring again to FIG. 1, the sensor-activated lighting system 10 include a plurality of hoist lines 24, 26, 28 and 30, each configured to support the vertical positioning of the frameworks 12a, 12b. In the illustrated embodiment, each of the hoist lines 24, 26, 28 and 30 has the form of wire rope and is connected to a support chain 34 that extends from and is connected to a ceiling structure 36. The support chains 34 are configured to work in cooperation with the plurality of hoist lines 24, 26, 28 and 30 to support the vertical positioning of the frameworks 12a, 12b. In other embodiments, it should be appreciated that the plurality of hoist lines 24, 26, 28 and 30 can have other suitable forms and can extend directly from and connect directly to the ceiling structure 36. It should also be appreciated that the plurality of hoist lines 24, 26, 28 and 30 can extend from and connect to other structures, devices or elements sufficient to connect the plurality of hoist lines 24, 26, 28 and 30 to the ceiling structure 36.

Referring again to FIG. 1, each of the frameworks 12a, 12b, includes one or more sensors 40. Each of the sensors 40 is configured to sense a parameter related to the plants 20. In the illustrated embodiment, the sensed parameter is a distance D from a plant canopy 42, schematically shown by substantially horizontal line A—A, to a lower surface 44 of the frameworks 12a, 12b. The term “plant canopy”, as used herein, is defined to mean an uppermost continuous layer of foliage of the plants 20.

Referring again to the embodiment illustrated in FIG. 1, each of the sensors 40 has the form of a non-contact, inductive proximity sensor. One non-limiting example of a suitable non-contact, inductive proximity sensor is model number XS218BLPB2, manufactured and marketed by Telemecanique Sensors, headquartered in Dayton, Ohio. However, in other embodiments, other suitable sensors sufficient to sense the distance D from the plant canopy 42 to a lower surface 44 of the frameworks 12a, 12b can be used.

In the embodiment illustrated in FIG. 1, each of the plurality of sensors 40 is described as the form of a non-contact, inductive proximity sensor. In alternate embodiments, it is contemplated that the sensors 40 can be different from each other, thereby resulting in different parameters being sensed by the sensor-activated lighting system 10.

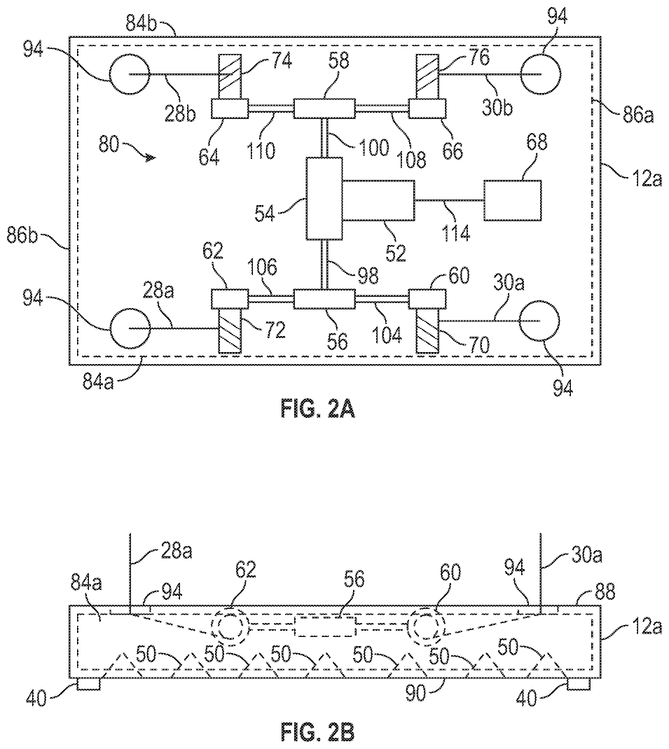

Referring now to the FIGS. 2A and 2B, the framework 12a is illustrated. The framework 12a is representative of the framework 12b. Generally, the framework 12a incorporates a hoisting mechanism, that is automatically actuated by the one or more sensors 40, to adjust the distance D from the plant canopy 42 to a lower surface 44 of the frameworks 12a. The framework 12a includes a plurality of lighting elements 50 (FIG. 2B, a motive force 52 (FIG. 2A), a first gear train assembly 54 (FIG. 2A), opposing second and third gear train assemblies 56, 58, a plurality of final gear train assemblies 60, 62, 64, 66 (FIG. 2A), a controller 68 (FIG. 2A), a plurality of hoist reels 70, 72, 74, 76 (FIG. 2A), and the plurality of hoist lines 28, 30 (FIG. 2B). Collectively, the motive force 52, first gear train assembly 54, second and third gear train assemblies 56, 58, the plurality of final gear train assemblies 60, 62, 64, 66, controller 68, plurality of hoist reels 70, 72, 74, 76 and the plurality of hoist lines 28, 30 are referred to as the “hoisting system” 80 (FIG. 2A).

Referring again to FIGS. 2A and 2B, the framework 12a is configured to house and support the plurality of lighting elements 50, the components comprising the hoisting system and the one or more sensors 40. In certain embodiments, the framework 12a has the form of an enclosure. In other embodiments, the framework 12a can have a form sufficient for placement within an enclosure. In the illustrated embodiment, the framework 12a includes opposing side walls 84a, 84b, opposing end walls 86a, 86b, an upper wall 88 and a lower wall 90. In the illustrated embodiment, the walls 84a, 84b, 86a, 86b, 88 and 90 are formed from structural materials, such as the non-limiting examples of plywood, reinforced polymeric materials, metallic panels and the like. In other embodiments, the walls 84a, 84b, 86a, 86b, 88 and 90 can be formed from other suitable structural materials, sufficient to house and support the plurality of lighting elements 50, the components comprising the hoisting system and the one or more sensors 40.

Referring again to FIGS. 2A and 2B, the upper wall 88 includes a plurality of apertures 94. The apertures 94 are configured to provide passage of the hoist lines 28, 30 through the upper wall 88. In the illustrated embodiment, the apertures 94 have a circular cross-sectional shape. However, in alternate embodiments, the apertures 94 can have other cross-sectional shapes sufficient to provide passage of the hoist lines 28, 30 through the upper wall 88.

Referring again to FIGS. 2A and 2B, each of the plurality of lighting elements 50 is configured to provide light spectrums and intensities suitable for the growing plants. Non-limiting examples of suitable lighting elements 50 include metal halide, ceramic metal halide, high pressure sodium vapor or LED-based technologies. It is also contemplated that combinations of suitable lighting elements 50 can be used. Since indoor plants can require both dark and light photoperiods, in certain instances, optionally a timer (not shown for purposes of clarity) can be incorporated and can be used to switch the light elements 50 on and off at desired intervals. In addition and also optionally, the lighting elements 50 can incorporate reflectors (not shown) to maximize light efficiency.

Referring now to FIG. 2A, the motive force 52 is configured to actuate the first gear train 54 in a manner such as to rotate first and second shafts 98, 100 extending therefrom, as directed by the controller 68. In the illustrated embodiment, the motive force 52 has the form of a 110 volt A.C. electric motor. However, in other embodiments, the motive force 52 can have other forms, including the non-limiting examples of a pneumatic actuator, a hydraulic actuator and the like, sufficient to rotate first and second shafts 98, 100.

Referring again to FIG. 2A, the first shaft 98 is connected to the second gear train assembly 56 and the second shaft 100 is connected to the third gear train assembly 58. Rotation of the first shaft 98 results in actuation of the second gear train assembly 56 and, in turn, rotation of the third and fourth shafts 104, 106. In a similar manner, rotation of the second shaft 100 results in actuation of the third gear train assembly 58 and, in turn, rotation of the fifth and sixth shafts 108, 110.

Referring again to FIGS. 2A, rotation of the third shaft 104 actuates the final gear train assembly 60. The final gear train assembly 60 is connected to the hoist reel 70 in a manner such that actuation of the final gear train assembly 60 results in rotation of the hoist reel 70. In similar manners, rotation of the fourth shaft 106 actuates the final gear train assembly 62 and subsequent rotation of the hoist reel 72, rotation of the fifth shaft 108 actuates the final gear train assembly 66 and subsequent rotation of the hoist reel 76 and rotation of the sixth shaft 110 actuates the final gear train assembly 66 and rotation of the hoist reel 74.

Referring again to FIG. 2A, the hoist line 30a is wound around the hoist reel 70, the hoist line 28a is wound around the hoist reel 72, the hoist line 30b is wound around the hoist reel 76 and the hoist line 28b is wound around the hoist reel 74. Rotation of the hoist reels 70, 72, 74, 76 results in retraction or extension of the associated hoist lines 30a, 28a, 28b, 30b.

Referring again to the embodiment shown in FIG. 2A, the controller 68 is in electrical communication with the motive force 52 via electrical connector 114. The controller 68 is configured for several functions. First, the controller 68 is configured to receive input signals from the sensors 40. Second, the controller 68 is configured to compare the input data from the sensor signals with stored data. Third, the controller 68 is configured to initiate actuation of the motive force 52 as a result of the comparison of the input data received from the sensors 40 with the stored data. Finally, the controller 68 is configured to terminate actuation of the motive force 52 as a result of the comparison of the input data received from the sensors 40 with the stored data.

Referring again to the embodiment shown in FIG. 2A, the controller 68 has the form of a microprocessor. In other embodiments, the controller 68 can have other forms including the non-limiting example of a micro controller having an embedded central processing unit, a memory and input/output modules, sufficient for the functions described herein.

Referring again to FIG. 2A, the controller 68 includes a power source (not shown for purposes of clarity). The power source is configured to power the plurality of sensors 40 and the motive force 52. In the illustrated embodiment, the power source is a rechargeable battery. However, in other embodiments, the power source can have other forms, including the non-limiting example of 110 Volt A.C. line connected to electrical sources external to the sensor-activated lighting system 10.

Referring again to FIGS. 2A and 2B, in operation, the data ascertained by the sensors 40 is sent by signal to the controller 68. In the illustrated embodiment, the sensors 40 are in wireless communication with the controller 68, although such is not necessary. Upon receipt of the sensed parameters, the controller 68 via comparison with stored data, will determine if the distance D from the plant canopy 42 of the plants 20 to the lighting elements 50 is optimal. If not, the controller 68 will actuate the motive force 52 to produce a rotational action to the first gear train assembly 54, which ultimately results in a retraction or extension of the hoist lines 28a, 28b, 30a, 30b and movement of the lighting elements 50 in a vertical direction, as indicated by direction arrows D1, D2.

One non-limiting example of the controller 68 comparing data ascertained by the sensors 40 with stored data is the automatic positioning of the distance D. In this example, the sensors 40 are configured to determine the actual distance D and a height the plants 20, which are transmitted to the controller 68. In turn, the controller 68 will compare the height of the plants 20 to an optimum distance D from the stored data and will actuate the motive force 52 to adjust the actual distance D to the optimum distance D. It should be appreciated that in other embodiments, the controller 68 can be configured to make other desired comparisons of the data ascertained by the sensors 40.

Referring again to FIG. 2A, it should be appreciated that the controller 68 can be downloaded with data via on-board mechanisms (not shown for purposes of clarity), such as the non-limiting example of a key pad, and/or remote mechanisms, such as the non-limiting example of a remote electronic device. It should also be appreciated that in operation the controller 68 can be controlled with on-board or remote mechanisms.

Referring now to FIG. 1, with the lighting elements 50 in an optimal position relative to the plant canopy 42 of the plants 20, without being held to the theory, it is believed the sensor-activated lighting system 10 will operate at the lowest power level while maintaining the proper amount of lumens provided to the plants 20. Operating at the optimum position also ensures that the sensor-activated lighting system 10 will function at the lowest possible costs while minimizing harmful heat conducted to the plant canopy 42 of the plants 20. It should be appreciated that minimizing the heat produced by the sensor-activated lighting system 10 also saves expense of excess air conditioning of the facility.

Referring again to FIG. 1, the sensor-activated lighting system 10 is configured for automatic repositioning based on sensed parameters by the sensors 40. The term “automatic”, as used herein, is defined to mean the movement of the sensor-activated lighting system 10 away from and toward the plant canopy 42 of the plants 20 is actuated by the input of the sensors 40 and occurs without human/manual intervention, thereby saving labor time and expense associated with frequent supervision and adjustments.

Referring again to FIG. 1, it is contemplated that the sensor-activated movement of the sensor-activated lighting system 10 can be controlled with sufficient and consistent precision that advantageously the yields and quality from the plants 20 will be higher than conventional lighting system controls.

While the sensor-activated lighting system 10 employ the hoisting system shown in FIGS. 2A, 2B, it should be appreciated that in other embodiments, other mechanisms, devices and structures can be used to automatically adjust the vertical position of the sensor-activated lighting system 10 relative to the plant canopy 42 of the plants 20.

While the embodiment of the sensor-activated lighting system 10 described above and shown in FIGS. 1, 2A have vertical movement activated by sensor activated parameters, it should be appreciated that in other embodiments, other mechanisms and devices can be used to activate the desired vertical movement. As non-limiting examples, the vertical movement of the sensor-activated lighting system 10 can be manually initiated by electrical toggle or key switches rather than by sensor signals.

While the embodiment of the sensor-activated lighting system 10 shown in FIG. 1, 2A and 2b uses the sensed parameter of the distance D (from the plant canopy 42 to the lighting elements 50), in other embodiments, the sensors 40 can provide data concerning other plant-related parameters, such as the non-limiting examples of heat emanating from the plants, light reflecting from the plants, moisture on or proximate the plants, moisture content of the growing medium 15 and the like. Using this data, the controller 68 can actuate the motive force 52 and adjust the vertical positioning of the lighting elements 50 are required.

In the embodiment illustrated in FIG. 1, the frameworks 12a, 12b are configured to simultaneously move in the same vertical direction and by the same adjustment distance. However, it is contemplated that in other embodiments, the frameworks 12a, 12b can move independently of each other and by distances that are different from each other.

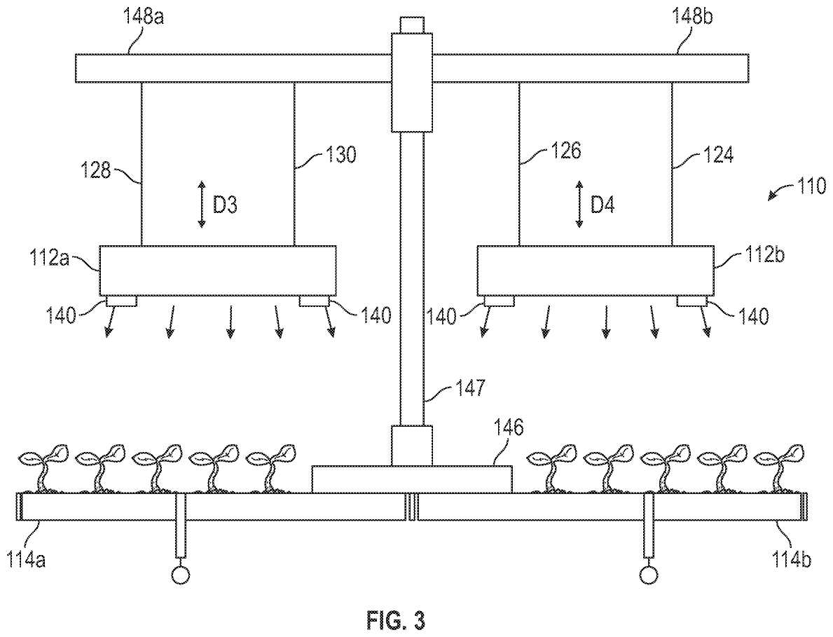

While the sensor-activated lighting system 10 is shown in FIG. 1 as being connected to the ceiling structure 36 of a facility, it should be appreciated that in other embodiments, the sensor-activated lighting system 10 can have a different mounting arrangement relative to the plants 20. Referring now to FIG. 3 for one non-limiting example of an alternate mounting arrangement, a sensor-activated lighting system 110 is shown in a mounted arrangement with adjoining agricultural growing tables 114a, 114b. While the illustrated embodiment shows a quantity of two plant cultivation tables 114a, 114b, it should be appreciated that in other embodiments, any quantity of plant cultivation tables can be joined together.

Referring again to FIG. 3, a support collar 146 spans the adjoining plant cultivation tables 114a, 114b and supports a vertical member 147. Opposing hanger members 148a, 148b extend from the vertical member 147. Frameworks 112a, 112b incorporating lighting elements (not shown), hoisting system components (not shown) and one or more sensors 140 hang from the hanger members 148a, 148b via the hoist lines 124, 126, 128, 130. In the illustrated embodiment, the frameworks 112a, 112b and the hoist lines 124, 126, 128, 130 are the same as, or similar to the frameworks 12a, 12b and the hoist lines 24, 26, 28, 30 shown in FIG. 1 and described above. In other embodiments, the frameworks 112a, 112b and the hoist lines 124, 126, 128, 130 can be different than the frameworks 12a, 12b and the hoist lines 24, 26, 28, 30.

Referring again to FIG. 3, in operation, the sensors 140 are configured to sense plant-related parameters and initiate vertical movement of the hoist lines 124, 126, 128, 130 as discussed above and as shown by direction arrows D3, D4.

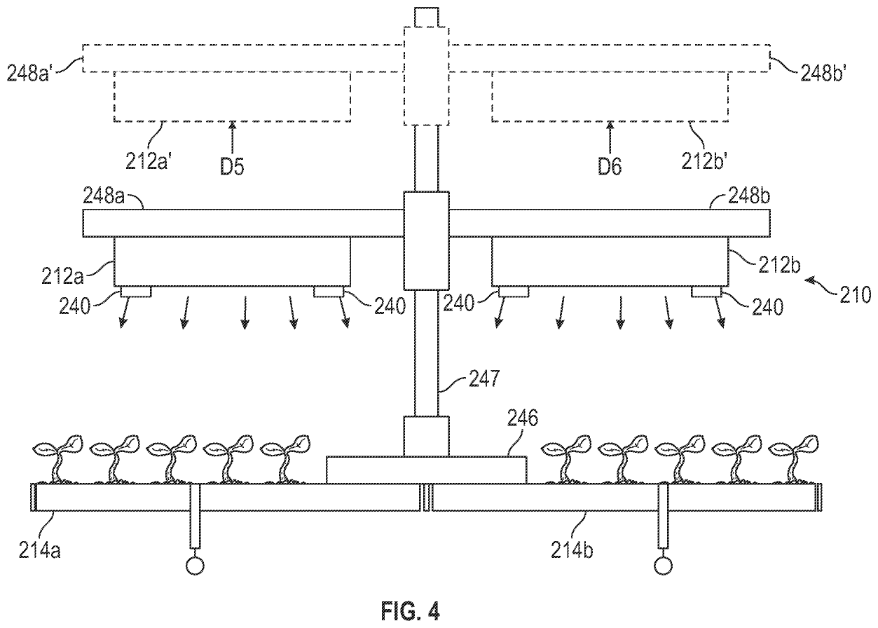

While the sensor-activated lighting system 110 shown in FIG. 3 is described above as incorporating hoist lines 124, 126, 128, 130, it is contemplated that in other embodiments, the hoist lines extending from the frameworks can be eliminated and the frameworks can be attached to movable portions of a mounting structure. Referring now to FIG. 4 for one non-limiting example of an alternate mounting arrangement, a sensor-activated lighting system 210 is shown in a mounted arrangement with adjoining agricultural growing tables 214a, 214b.

Referring again to FIG. 4, a support collar 246 spans the adjoining plant cultivation tables 214a, 214b and supports a vertical member 247. Opposing hanger members 248a, 248b extend from the vertical member 247. Frameworks 212a, 212b incorporating lighting elements (not shown), hoisting system components (not shown) and one or more sensors 240 are devoid of hoist lines and are coupled to the hanger members 248a, 248b. In the illustrated embodiment, the frameworks 212a, 212b are the same as, or similar to the frameworks 12a, 12b shown in FIG. 1 and described above. In other embodiments, the frameworks 212a, 212b can be different than the frameworks 12a, 12b and the hoist lines 24, 26, 28, 30.

Referring again to FIG. 4, the hanger members 248a, 248b are configured for vertical movement as guided by the vertical member 247. The frameworks 212a, 212b, coupled to the hanger members 248a, 248b, are configured for vertical movement as the hanger members 248a, 248b vertically move.

Referring again to FIG. 4, in operation, the sensors 240 are configured to sense plant-related parameters and initiate vertical movement of the hanger members 248a, 248b in a manner similar discussed above. The hanger members 248a, 248b are shown in a first vertical position. The hanger members shown schematically at 248a′, 248b′ and the coupled frameworks 212a′, 212b′ are adjusted, as shown by direction arrows D5, D6, to a second vertical position.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A sensor-activated lighting system for use with agricultural growing tables, comprising:
a plurality of lighting elements positioned proximate to one or more plants, the plurality of lighting elements configured to provide light spectrums and intensities suitable for the growing the one or more plants;
a plurality of sensors mounted in proximity to the one or more plants and configured to sense a parameter related to the plurality of plants, the plurality of sensors further configured to communicated the sensed parameter;
a controller is configured to receive communication from the plurality of sensors; and
a motive force is in communication with the controller and is configured to actuate movement the plurality of lighting elements in a vertical direction as directed by the controller in response to the received communication;
wherein the sensors, controller and the motive force cooperate to automate the vertical movement of the plurality of lighting elements based on the parameter sensed by the plurality of sensors, thereby maximizing a lighting efficiency of the plurality of lighting elements while avoiding the infliction of harm to the one or more plants due to excessive light intensities.

2. The sensor-activated lighting system for use with agricultural growing tables of claim 1, wherein each of the plurality of lighting elements has the form of ceramic metal halide technology.

3. The sensor-activated lighting system for use with agricultural growing tables of claim 1, wherein each of the plurality of lighting elements is housed in a framework and wherein the framework moves in a vertical direction as directed by the motive force.

4. The sensor-activated lighting system for use with agricultural growing tables of claim 3, wherein each of the plurality of sensors is attached to the framework and moves in a vertical direction as directed by the motive force.

5. The sensor-activated lighting system for use with agricultural growing tables of claim 1, wherein each of the plurality of sensors has the form of a non-contact, inductive proximity sensor.

6. The sensor-activated lighting system for use with agricultural growing tables of claim 1, wherein the sensed parameter is a distance formed from a plant canopy to a lower surface of a framework enclosing the plurality of lighting elements.

7. The sensor-activated lighting system for use with agricultural growing tables of claim 1, wherein the motive force is an electrical motor.

8. The sensor-activated lighting system for use with agricultural growing tables of claim 1, wherein the controller has the form of a micro controller having an embedded central processing unit, a memory and input/output modules.

9. The sensor-activated lighting system for use with agricultural growing tables of claim 8, wherein the controller compares the communication received from the plurality of sensors with stored data.

10. The sensor-activated lighting system for use with agricultural growing tables of claim 9, wherein the motive force is configured to automate the vertical movement of the plurality of lighting elements based on the comparison of the parameter sensed by the plurality of sensors and the stored data.

11. A method of using a sensor-activated lighting system with an agricultural growing table, the method comprising the steps of:
positioning a plurality of lighting elements proximate to one or more plants, the plurality of lighting elements configured to provide light spectrums and intensities suitable for the growing the one or more plants;
mounting a plurality of sensors in proximity to the one or more plants;
configuring the plurality of sensors to sense one or more parameters related to the plurality of plants;
communicating the one or more sensed parameters to a controller; and
actuating movement of the plurality of lighting elements in a vertical direction with a motive force as directed by the controller in response to the sensed parameter, wherein the plurality of sensors and the motive force cooperate to automate the vertical movement of the plurality of lighting elements based on the parameter sensed by the plurality of sensors, thereby maximizing a lighting efficiency of the plurality of lighting elements while avoiding the infliction of harm to the indoor door plants due to excessive light intensities.

12. The method of claim 11, including the step of forming each of the plurality of lighting elements with ceramic metal halide technology.

13. The method of claim 11, including the step of housing each of the plurality of lighting elements within a framework and wherein the framework moves in a vertical direction as directed by the motive force.

14. The method of claim 13, including the step attaching each of the plurality of sensors to the framework.

15. The method of claim 14, including the step of forming each of the plurality of sensors has the form of a of a non-contact, inductive proximity sensor.

16. The method of claim 11, including the step of sensing a distance formed from a plant canopy to a lower surface of a framework enclosing the plurality of lighting elements.

17. The method of claim 11, wherein the motive force is an electrical motor.

18. The method of claim 11, including the step of forming a controller having the form of a micro controller having an embedded central processing unit, a memory and input/output modules.

19. The method of claim 11, including the step of comparing the communication received from the plurality of sensors with stored data.

20. The method of claim 19, including the step of automating the vertical movement of the plurality of lighting elements based on the comparison of the parameter sensed by the plurality of sensors and the stored data.
